(19) United States
(12) Patent Application Publication
(10) Pub. No.: US 2026/0208233 A1
(43) Pub. Date: Jul. 23, 2026

(54) METHOD AND APPARATUS FOR CONTROLLING CLEANING DEVICE, AND STORAGE MEDIUM AND CLEANING DEVICE

(71) Applicant: Beijing Roborock Innovation Technology Co., Ltd., Beijing (CN)

(72) Inventors: Tongsheng ZHANG, Beijing (CN); Kaijing WANG, Beijing (CN)

(21) Appl. No.: 19/540,162

(22) Filed: Feb. 13, 2026

Related U.S. Application Data
(63) Continuation of application No. PCT/CN2024/117812, filed on Sep. 9, 2024.

(30) Foreign Application Priority Data
Aug. 25, 2023 (CN) 202311091448.4

(51) Int. Cl. B08B 1/30; B08B 1/34

(52) U.S. Cl. CPC B08B 1/30; B08B 1/34; A47L 2201/04

(57) ABSTRACT

Provided are a method for controlling a cleaning device, a storage medium and a cleaning device. The method includes: in response to detecting the presence of an obstacle gap in an initial travel direction of a cleaning device, acquiring a gap width of the obstacle gap; if the gap width is less than a preset width threshold, planning a target travel trajectory that matches the obstacle gap for the cleaning device; and controlling the cleaning device to move according to the target travel trajectory, so as to pass through the obstacle gap.

### CROSS REFERENCE TO RELATED APPLICATIONS

The present disclosure is a continuation application of International Application No. PCT/CN2024/117812, filed on Sep. 9, 2024, which is based upon and claims priority to Chinese Patent Application No. 202311091448.4, filed on Aug. 25, 2023 and entitled “METHOD AND APPARATUS FOR CONTROLLING CLEANING DEVICE, AND STORAGE MEDIUM AND CLEANING DEVICE”, the entire content of which is incorporated herein by reference.

### TECHNICAL FIELD

The present disclosure relates to the field of cleaning device control technologies, and in particular to a cleaning device control method and apparatus, a storage medium and a cleaning device.

### BACKGROUND

In the prior art, a cleaning device, when encountering an obstacle gap in the process of traveling, will directly make a turn to enter the obstacle gap. If the action of entering the obstacle gap fails, the cleaning device will exit and perform other actions. It is not difficult to understand that this way causes scratches between the cleaning device and obstacles, damaging both the obstacles (for example, a wall) and the cleaning device itself. Based on this, how to avoid scratches generated between the cleaning device and the surrounding obstacles is an urgent technical problem to be solved.

### SUMMARY

Embodiments of the present disclosure provide a cleaning device control method and apparatus, a storage medium and a cleaning device. Based on the technical solutions provided by the present disclosure, scratches generated between the cleaning device and surrounding obstacles can be avoided.

Other features and advantages of the present disclosure will become apparent from the following detailed descriptions, or may be acquired in part by practice of the present disclosure.

According to a first aspect of embodiments of the present disclosure, a method for controlling a cleaning device is provided. The method includes: in response to detecting the presence of an obstacle gap in an initial travel direction of the cleaning device, acquiring a gap width of the obstacle gap; if the gap width is less than a preset width threshold, planning a target travel trajectory that matches the obstacle gap for the cleaning device; and controlling the cleaning device to move according to the target travel trajectory, so as to pass through the obstacle gap.

In some embodiments of the present disclosure, based on the above-described solution, the gap width is a length of an endpoint connection line, the endpoint connection line is a line that connects two endpoints of the obstacle gap, the two endpoints include a starting endpoint and an ending endpoint of the obstacle gap in the initial travel direction, and planning the target travel trajectory that matches the obstacle gap for the cleaning device includes: acquiring a first positional relationship between a geometric center of the cleaning device and the endpoint connection line; and based on the first positional relationship, planning the target travel trajectory that matches the obstacle gap for the cleaning device.

In some embodiments of the present disclosure, based on the above-described solution, the method further includes: detecting, before acquiring the first positional relationship between the geometric center of the cleaning device and the endpoint connection line, a second positional relationship between a reference ray and a first reference connection line, the reference ray taking an initial position of the cleaning device as a ray starting point and the initial travel direction of the cleaning device as a ray direction, the first reference connection line being a line that connects a geometric center of the cleaning device and the starting endpoint; and if the second positional relationship meets a first preset positional relationship, acquiring the first positional relationship between the geometric center of the cleaning device and the endpoint connection line.

In some embodiments of the present disclosure, based on the above-described solution, the first preset positional relationship includes a case where an absolute value of a first angle between the reference ray and the first reference connection line exceeds a first preset angle threshold.

In some embodiments of the present disclosure, based on the above-described solution, the method further includes: detecting, before acquiring the first positional relationship between the geometric center of the cleaning device and the endpoint connection line, whether a reference ray intersects with an extension line of the endpoint connection line, the reference ray taking an initial position of the cleaning device as a ray starting point and the initial travel direction of the cleaning device as a ray direction; and acquiring the first positional relationship between the geometric center of the cleaning device and the endpoint connection line if the extension line of the endpoint connection line intersects with the reference ray.

In some embodiments of the present disclosure, based on the above-described solution, the method further includes: if the extension line of the endpoint connection line does not intersect with the reference ray, planning a curved trajectory for the cleaning device, and determining whether any other obstacle exists on the curved trajectory; taking the curved trajectory as the target travel trajectory if no other obstacles exist on the curved trajectory; and planning a linear trajectory for the cleaning device as the target travel trajectory if another obstacle exists on the curved trajectory, the linear trajectory being parallel to the endpoint connection line.

In some embodiments of the present disclosure, based on the above-described solution, based on the first positional relationship, planning the target travel trajectory that matches the obstacle gap for the cleaning device includes: planning a linear trajectory for the cleaning device as the target travel trajectory if a foot of a perpendicular from the geometric center to the endpoint connection line is close to the ending endpoint, the linear trajectory being parallel to the endpoint connection line.

In some embodiments of the present disclosure, based on the above-described solution, based on the first positional relationship, planning the target travel trajectory that matches the obstacle gap for the cleaning device includes: if a foot of a perpendicular from the geometric center to the endpoint connection line is close to the starting endpoint, planning a curved trajectory for the cleaning device, and determining whether any other obstacle exists on the curved trajectory; taking the curved trajectory as the target travel trajectory if no other obstacles exist on the curved trajectory; and planning a linear trajectory for the cleaning device as the target travel trajectory if another obstacle exists on the curved trajectory, the linear trajectory being parallel to the endpoint connection line.

In some embodiments of the present disclosure, based on the above-described solution, the curved trajectory is either an arc trajectory or a polyline trajectory.

In some embodiments of the present disclosure, based on the above-described solution, the gap width is a length of an endpoint connection line, and the endpoint connection line is a line that connects two endpoints of the obstacle gap; and the method further includes: detecting, after planning the target travel trajectory that matches the obstacle gap for the cleaning device, a third positional relationship between a perpendicular from a geometric center of the cleaning device to the endpoint connection line and the endpoint connection line; and if the third positional relationship meets a second preset positional relationship, triggering the cleaning device to rotate in place by a first angle to control the cleaning device to move according to the target travel trajectory.

In some embodiments of the present disclosure, based on the above-described solution, the second preset positional relationship includes a case where the perpendicular from the geometric center of the cleaning device to the endpoint connection line intersects with the endpoint connection line.

In some embodiments of the present disclosure, based on the above-described solution, the gap width is a length of an endpoint connection line, the endpoint connection line is a line that connects two endpoints of the obstacle gap, the two endpoints include a starting endpoint and an ending endpoint of the obstacle gap in the initial travel direction, and in a process of controlling the cleaning device to move according to the target travel trajectory, the method further includes: detecting an absolute value of a second angle between a current travel direction of the cleaning device and a second reference connection line, the second reference connection line being a line that connects the geometric center of the cleaning device and the ending endpoint; and when the absolute value of the second angle exceeds a second preset angle threshold, triggering the cleaning device to rotate by a second angle according to a predetermined action, so as to control the cleaning device to continue to move in the initial travel direction and depart from the obstacle gap.

In some embodiments of the present disclosure, based on the above-described solution, the method further includes: controlling the cleaning device to directly enter the obstacle gap if the gap width is greater than or equal to the preset width threshold.

In some embodiments of the present disclosure, based on the above solution, the preset width threshold is greater than or equal to a body diameter of the cleaning device.

According to a second aspect of the embodiments of the present disclosure, a non-transitory computer-readable storage medium storing at least one program code therein is provided, wherein the at least one program code is loaded and executed by a processor to implement operations executed by the method according to any one of embodiments in the first aspect.

According to a third aspect of the embodiments of the present disclosure, a cleaning device is provided. The cleaning device includes one or more processors and one or more memories, wherein the one or more memories store at least one program code, and the at least one program code is loaded and executed by the one or more processors to implement operations executed by the method according to any one of embodiments in the first aspect.

It is to be understood that both the foregoing general descriptions and the following detailed descriptions are exemplary and explanatory only and are not restrictive of the present disclosure.

### BRIEF DESCRIPTION OF THE DRAWINGS

The accompanying drawings herein, which are incorporated into the Description and constitute a part of the Description, show embodiments conforming to the present disclosure, and are used to explain the principles of the present disclosure together with the Description. Apparently, the accompanying drawings in the following description show merely some embodiments of the present disclosure. In the accompanying drawings:

FIG. 1 is a schematic flowchart of a cleaning device control method according to an embodiment of the present disclosure;

FIG. 2 is a schematic diagram of a scenario showing an obstacle gap according to an embodiment of the present disclosure;

FIG. 3 is a detailed schematic flowchart of planning a target travel trajectory for a cleaning device that matches the obstacle gap according to an embodiment of the present disclosure;

FIG. 4 is a schematic diagram of a scenario showing a first positional relationship between a geometric center of the cleaning device and an endpoint connection line according to an embodiment of the present disclosure;

FIG. 5 is a schematic diagram of a scenario showing a first positional relationship between a geometric center of the cleaning device and an endpoint connection line according to an embodiment of the present disclosure;

FIG. 6 is a schematic diagram of a scenario where a linear trajectory is planned for the cleaning device as the target travel trajectory according to an embodiment of the present disclosure;

FIG. 7 is a schematic diagram of a scenario where another obstacle exists on a curved trajectory according to an embodiment of the present disclosure;

FIG. 8 is a schematic diagram of a scenario where another obstacle exists on a curved trajectory according to an embodiment of the present disclosure;

FIG. 9 is a schematic diagram of a scenario showing a second positional relationship between a reference ray and a first reference connection line according to an embodiment of the present disclosure;

FIG. 10 is a schematic diagram of a scenario showing whether an extension line of the endpoint connection line intersects with the reference ray according to an embodiment of the present disclosure;

FIG. 11 is a schematic diagram of a scenario showing a third positional relationship between the perpendicular from the geometric center of the cleaning device to the endpoint connection line and the endpoint connection line according to an embodiment of the present disclosure;

FIG. 12 is a schematic diagram of a scenario where the cleaning device rotates in place by a first angle according to an embodiment of the present disclosure;

FIG. 13 is a schematic diagram of a scenario where the cleaning device rotates by a second angle in accordance with a predetermined action according to an embodiment of the present disclosure;

FIG. 14 is a block diagram of a cleaning device control apparatus according to an embodiment of the present disclosure; and

FIG. 15 is a schematic structural diagram of the cleaning device according to an embodiment of the present disclosure.

### DETAILED DESCRIPTION

Exemplary embodiments will now be described more fully with reference to the accompanying drawings. However, the exemplary embodiments can be implemented in various ways and shall not be construed as limited to the embodiments set forth herein; rather, these embodiments are provided to make the present disclosure comprehensive and complete, and fully convey the concept of the exemplary embodiments to those skilled in the art.

Moreover, the features, structures, or characteristics described above may be combined in one or more embodiments in any suitable manner. In the following description, numerous specific details will be provided to give a thorough understanding of the embodiments of the present disclosure. However, those skilled in the art will recognize that the technical solutions of the present disclosure may be practiced without one or more of the specific details, or with the use of other methods, components, apparatuses, steps, etc. In other cases, well-known methods, apparatuses, implementations or operations are not shown or described in detail to avoid obscuring aspects of the present disclosure.

The block diagrams shown in the drawings are only functional entities, and do not necessarily correspond to physically independent entities. That is, these functional entities may be implemented in the form of software, or in one or more hardware modules or integrated circuits, or in different networks and/or processor apparatuses and/or microcontroller apparatuses.

The flowcharts shown in the drawings are merely illustrative, and do not necessarily include all content and operations/steps, nor do they have to be executed in the described sequence. For example, some operations/steps may be decomposed, while others may be incorporated or partially incorporated. Therefore, the actual sequence of execution may change according to actual situations.

It should be understood that the term “a plurality of” used herein refers to two or more than two. The term “and/or” used herein describes an associative relationship between associated objects, indicating three possible scenarios. For example, “A and/or B” may represent: A exists alone, A and B exist concurrently, or B exists alone. The character “/” in this document generally signifies an “or” relationship between the preceding and following associated objects.

It should be noted that the terms “first”, “second” and the like in the description and the claims of the present disclosure and in the aforementioned accompanying drawings are used for the purpose of distinguishing similar objects instead of indicating a particular order or sequence. It should be understood that objects used in this way are interchangeable where appropriate, such that the embodiments of the present disclosure described herein can be implemented in a sequence other than those illustrated or described herein.

To make the objectives, technical solutions and advantages of the present disclosure clearer, the technical solutions in the embodiments of the present disclosure will be clearly and completely described below with reference to the accompanying drawings in the embodiments of the present disclosure. Apparently, the described embodiments are only some, but not all of the embodiments of the present disclosure. All other embodiments acquired by those of ordinary skills in the art without creative efforts based on the embodiments in the present disclosure are within the protection scope of the present disclosure.

Some embodiments of the present disclosure will be described in detail with reference to the accompanying drawings. In the case of no conflict, the embodiments in the present disclosure and the features in the embodiments may be combined with each other.

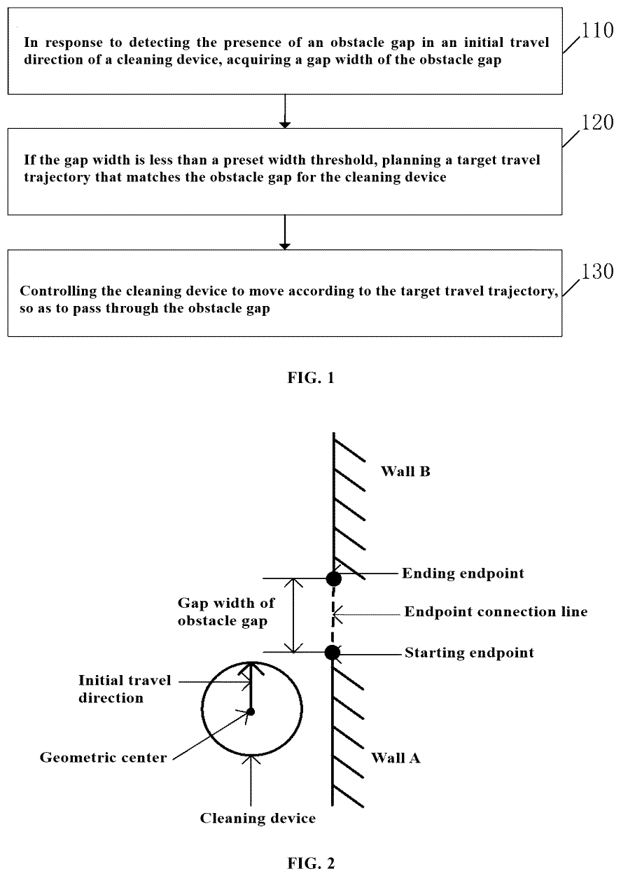

Refer to FIG. 1, which is a schematic flowchart of a cleaning device control method according to an embodiment of the present disclosure. The method specifically includes the following steps S110 to S130.

In S110, in response to detecting the presence of an obstacle gap in an initial travel direction of a cleaning device, a gap width of the obstacle gap is acquired.

It should be noted that the cleaning device in the present disclosure refers to a smart device with a cleaning function, for example, a robot vacuum cleaner.

It should also be noted that obstacles forming the obstacle gap may be two walls, a column and a wall (e.g., a gap formed between a table leg and a wall), two pillars (e.g., a gap formed between two table legs), etc., which are not specifically limited in the present disclosure. The following embodiments are illustrated by taking a gap formed between walls as an example of the obstacle gap.

It should also be noted that the technical solution of the present disclosure may be a technical solution executed by the cleaning device in establishing a cleaning contour for a room for the first time, or a technical solution executed by the cleaning device during its first execution of a cleaning task for the room, which is not specifically limited in the present disclosure.

It should also be noted that the initial travel direction is a direction in which the cleaning device travels when detecting the obstacle gap. Exemplarily, if the cleaning device detects the obstacle gap while traveling along a wall edge A, the initial travel direction is parallel to the wall edge A.

In some implementations, a sensor for detecting the obstacle gap may be mounted on the cleaning device, and the sensor may be always kept in a detecting state in the travel process of the cleaning device, so that whether an obstacle gap exists in a travel direction of the cleaning device can be detected in real time. It can be understood that the sensor may detect the presence of one or more obstacle gaps in the travel direction at the same time.

In some implementations, after detecting the obstacle gap, the cleaning device may calculate the gap width of the obstacle gap using an associated algorithm, which can guide the cleaning device to take further related actions.

In some implementations, the gap width of the obstacle gap is a length of an endpoint connection line, the endpoint connection line is a line that connects two endpoints of the obstacle gap; and the two endpoints include a starting endpoint and an ending endpoint of the obstacle gap in the initial travel direction.

In order to make those skilled in the art better understand the obstacle gap in the present disclosure, an example will be provided below with reference to FIG. 2.

Refer to FIG. 2, which is a schematic diagram of a scenario showing an obstacle gap according to an embodiment of the present disclosure.

A scenario corresponding to FIG. 2 is described as below. The cleaning device detects the presence of an obstacle gap between a wall A and a wall B in the initial travel direction, and the gap width of the obstacle gap is a length of a line that connects an endpoint on the wall A and an endpoint on the wall B. As can be seen from FIG. 2, the starting endpoint is located on the wall A, and the ending endpoint is located on the wall B; and the starting endpoint and the ending endpoint in FIG. 2 are located in the initial travel direction of the obstacle gap.

In some implementations, the starting endpoint located on the wall A in FIG. 2 may be considered as an intersection point between the ground and a position where the wall A breaks in the initial travel direction of the cleaning device. The ending endpoint located on the wall B in FIG. 2 may be considered as an intersection point between the ground and a position on the wall B closest to the cleaning device.

Continuing to refer to FIG. 1, in S120, if the gap width is less than a preset width threshold, a target travel trajectory matching the obstacle gap is planned for the cleaning device.

In some implementations, the preset width threshold may be set to be greater than or equal to a body diameter of the cleaning device. Exemplarily, assuming that the body diameter of the cleaning device is 2R (R is a radius of the cleaning device), the preset width threshold may be set to be greater than or equal to 2R. The preset width threshold may also be set to other dimensions as required.

It can be understood that if the gap width of the obstacle gap is less than the body diameter of the cleaning device, without planning a target travel path matching the obstacle gap for the cleaning device, the cleaning device, when reaching the obstacle gap, would directly attempt to enter the obstacle gap. Since the gap width of the obstacle gap cannot accommodate the whole machine body of the cleaning device, this would cause the cleaning device to fail to enter the obstacle gap. Consequently, after the failure, the cleaning device may take related actions such as retreating and rotating to enable the machine body to break free, and scratches may occur between the cleaning device and the obstacle gap in this process. Based on this, setting the preset width threshold to be greater than or equal to the body diameter can prevent the cleaning device from directly entering the obstacle gap when the gap width of the obstacle gap is less than the body diameter of the cleaning device, thereby avoiding scratches between the cleaning device and the obstacle gap.

In some implementations, if the gap width is less than the preset width threshold, a linear trajectory or a curved trajectory may be planned as the target travel trajectory matching the obstacle gap.

In S120, at least four specific implementations for planning a target travel trajectory that matches an obstacle gap for the cleaning device are provided.

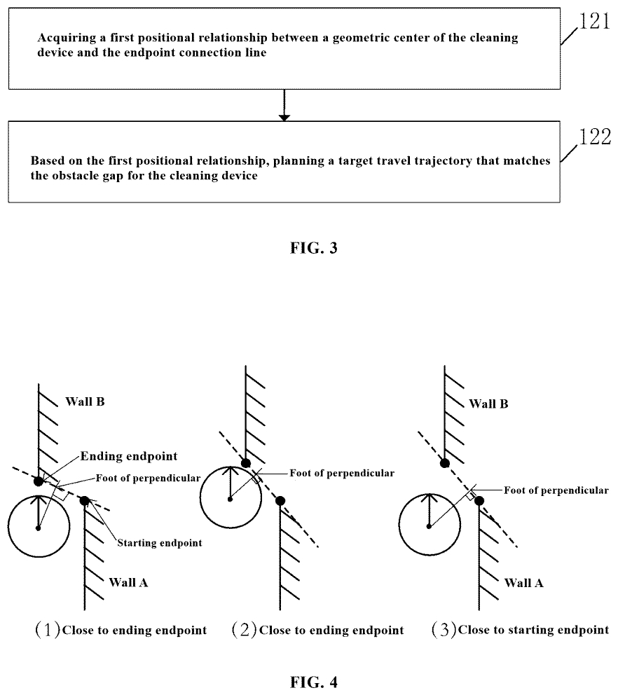

The first implementation may be executed according to the steps shown in FIG. 3.

Refer to FIG. 3, which is a detailed schematic flowchart of planning a target travel trajectory that matches the obstacle gap for the cleaning device according to an embodiment of the present disclosure. Specifically, steps S121 to S122 are included.

In S121, a first positional relationship between a geometric center of the cleaning device and the endpoint connection line is acquired.

In some implementations, after determining that the gap width of the obstacle gap is less than the preset width threshold, the cleaning device starts to acquire the first positional relationship between the geometric center of the cleaning device and the endpoint connection line.

It should be noted that the first positional relationship between the geometric center of the cleaning device and the endpoint connection line includes: a foot of a perpendicular from the geometric center of the cleaning device to the endpoint connection line is close to the starting endpoint, and the foot of the perpendicular from the geometric center of the cleaning device to the endpoint connection line is close to the ending endpoint.

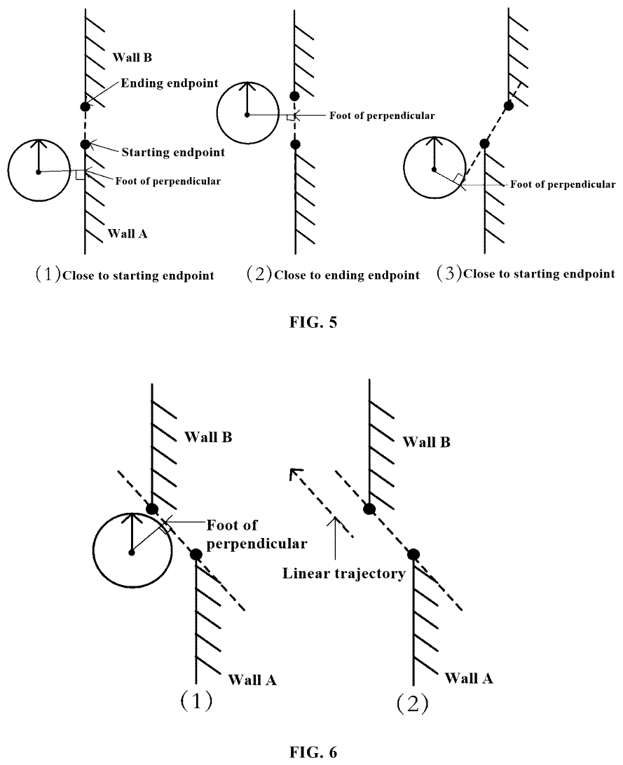

In order to make those skilled in the art better understand the first positional relationship in the embodiment, an example will be provided below with reference to FIGS. 4 and 5.

FIGS. 4 and 5 show several possible scenarios of the first positional relationship.

A scenario shown in FIG. 4 is described as below. The wall B is in a protruding state relative to the wall A, i.e., the wall A and the wall B are not on the same straight line. The corresponding first positional relationship in FIG. 4(1) is described as below: The foot of the perpendicular from the geometric center of the cleaning device to the endpoint connection line is close to the ending endpoint (being close to the ending endpoint is caused by excessive protrusion of the wall B relative to the wall A). The corresponding first positional relationship in FIG. 4(2) is described as below: The foot of the perpendicular from the geometric center of the cleaning device to the endpoint connection line is close to the ending endpoint (being close to the ending endpoint caused by the fact that the time at which the cleaning device detects the obstacle gap is slightly delayed, and the obstacle gap is not detected until the cleaning device travels along the wall B to lie between the two endpoints of the obstacle gap, so that the foot of the perpendicular is close to the ending endpoint). The corresponding first positional relationship in FIG. 4(3) is described as below: The foot of the perpendicular from the geometric center of the cleaning device to the endpoint connection line is close to the starting endpoint.

A scenario shown in FIG. 5 is described as below. The wall A and the wall B in FIG. 5(1)-(2) are located on the same straight line, in FIG. 5(3), the wall B is in a recessed state relative to the wall A, i.e., the wall A and the wall B are not on the same straight line. The corresponding first positional relationship in FIG. 5(1) is described as below: The foot of the perpendicular from the geometric center of the cleaning device to the endpoint connection line is close to the starting endpoint. The corresponding first positional relationship in FIG. 5(2) is described as below: the foot of the perpendicular from the geometric center of the cleaning device to the endpoint connection line is close to the ending endpoint (being close to the ending endpoint caused by the fact that the time at which the cleaning device detects the obstacle gap is slightly delayed, and the obstacle gap is not detected until the cleaning device travels along the wall B to lie between the two endpoints of the obstacle gap, so that the foot of the perpendicular is close to the ending endpoint). The corresponding first positional relationship in FIG. 5(3) is described as below: The foot of the perpendicular from the geometric center of the cleaning device to the endpoint connection line is close to the starting endpoint.

It should be noted that FIGS. 4 and 5 only show several possible first positional relationships. Actually, there are more other scenarios of the first positional relationship between the geometric center of the cleaning device and the endpoint connection line, which will not be exemplified one by one in the present disclosure.

Continuing to refer to FIG. 3, in S122, a target travel trajectory matching the obstacle gap is planned for the cleaning device based on the first positional relationship.

In some implementations, in S122, a linear trajectory is planned for the cleaning device as the target travel trajectory if the foot of the perpendicular from the geometric center to the endpoint connection line is close to the ending endpoint, wherein the linear trajectory is parallel to the endpoint connection line.

It should be noted that planning the curved trajectory for the obstacle gap enables the cleaning device to sweep a larger area, so that the curved trajectory is a travel trajectory that is preferably planned. However, in the case where the foot of the perpendicular from the geometric center of the cleaning device to the endpoint connection line is close to the ending endpoint, if the curved trajectory is still planned for the cleaning device, the cleaning device will fail to turn out of the obstacle gap in the process of moving along the curved trajectory, and finally the machine body may scratch the obstacle where the ending endpoint is located, causing damages to the obstacle and the cleaning device. Therefore, in the case where the foot of the perpendicular from the geometric center of the cleaning device to the endpoint connection line is close to the ending endpoint, it is necessary to plan a linear trajectory for the cleaning device as the target travel trajectory.

According to the schematic diagram of the scenario showing the first positional relationship shown in FIGS. 4 and 5, it can be known that the reason why the foot of the perpendicular from the geometric center of the cleaning device to the endpoint connection line is close to the ending endpoint may be that the wall B protrudes excessively from the wall A, or that the time at which the cleaning device detects the obstacle gap is slightly delayed, and the obstacle gap is not detected until the cleaning device travels along the wall B to lie between the two endpoints of the obstacle gap, so that the foot of the perpendicular is close to the ending endpoint. Therefore, in this case, a linear trajectory may be planned for the cleaning device as the target travel trajectory.

In order to make those skilled in the art better understand the embodiment, an example will be provided below with reference to FIG. 6.

Refer to FIG. 6, which is a schematic diagram of a scenario where a linear trajectory is planned for the cleaning device as the target travel trajectory according to an embodiment of the present disclosure.

A scenario corresponding to FIG. 6 is described as below. In FIG. 6(1), the time at which the cleaning device detects the obstacle gap is slightly delayed, and the obstacle gap is not detected until the cleaning device travels along the wall B to lie between the two endpoints of the obstacle gap, so that the foot of the perpendicular from the geometric center of the cleaning device to the endpoint connection line is close to the ending endpoint. Therefore, a linear trajectory is planned for the cleaning device as the target travel trajectory, as shown in FIG. 6(2).

It can be understood that in this embodiment, in the case where the foot of the perpendicular from the geometric center of the cleaning device to the endpoint connection line is close to the ending endpoint, planning the linear trajectory for the cleaning device can effectively avoid scratches between the cleaning device and the obstacle where the ending endpoint is located.

In some implementations, in step S122, if the foot of the perpendicular from the geometric center to the endpoint connection line is close to the starting endpoint, a curved trajectory is planned for the cleaning device, and whether any other obstacle exists on the curved trajectory is determined; the curved trajectory is taken as the target travel trajectory if no other obstacles exist on the curved trajectory; and a linear trajectory is planned for the cleaning device as the target travel trajectory if any other obstacle exists on the curved trajectory, the linear trajectory being parallel to the endpoint connection line.

It should be noted that in the case where the foot of the perpendicular from the geometric center of the cleaning device to the endpoint connection line is close to the starting endpoint, planning the curved trajectory for the cleaning device enables the cleaning device to sweep a larger area. However, if any other obstacle exists on a planned curve, the cleaning device can be prevented from moving along the curved trajectory. Therefore, in this case, it is necessary to adjust the curved trajectory to the linear trajectory, so that the cleaning device can successfully pass through the obstacle gap.

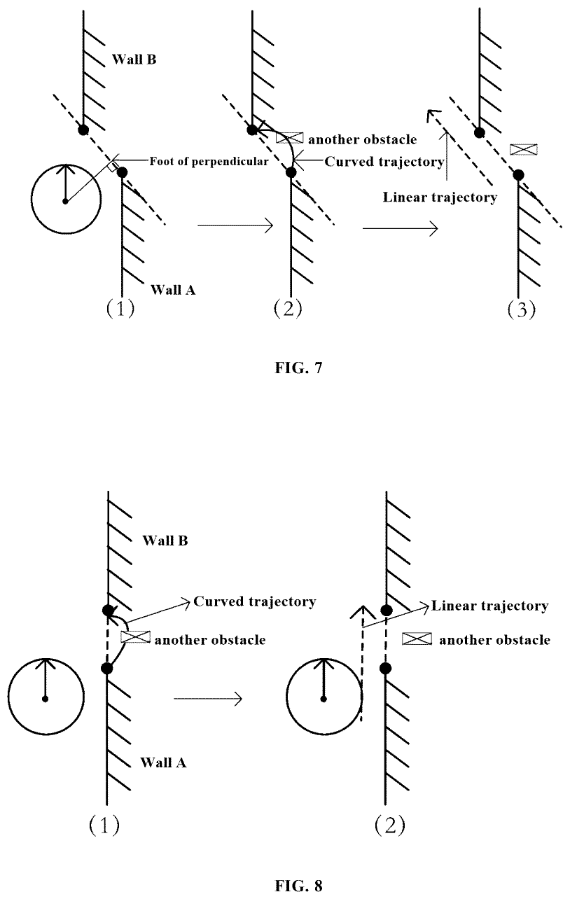

In order to make those skilled in the art better understand the embodiment, an example will be provided below with reference to FIGS. 7 and 8.

A scenario corresponding to FIG. 7 is described as below. In FIG. 7, the wall B is in a protruding state relative to the wall A. In FIG. 7(1), it is determined that the foot of the perpendicular from the geometric center of the cleaning device to the endpoint connection line is close to the starting endpoint, so a curved trajectory is first planned for the cleaning device. In FIG. 7(2), it is determined that any other obstacle exists on the planned curved trajectory, the cleaning device is prevented from moving along the curved trajectory. In FIG. 7(3), it is determined that any other obstacle exists on the curved trajectory, so the curved trajectory is adjusted to the linear trajectory as the target travel trajectory of the cleaning device.

A scenario corresponding to FIG. 8 is described as below. In FIG. 8, the wall B and the wall A are located on the same straight line. In FIG. 8(1), it is determined that the foot of the perpendicular from the geometric center of the cleaning device to the endpoint connection line is close to the starting endpoint, so a curved trajectory is planned for the cleaning device. In FIG. 8(2), it is determined that any other obstacle exists on the planned curved trajectory, so the planned curved trajectory is adjusted to a linear trajectory as the target travel trajectory of the cleaning device.

As can be seen from both FIGS. 7 and 8, the determined linear trajectory is the endpoint connection line parallel to the obstacle gap, so that the cleaning device can clean a larger area.

The second implementation in S120 may be executed according to the following steps.

The following steps S100 to S200 are executed first, and then the above steps S121 to S122 are executed.

In S100, a second positional relationship between a reference ray and a first reference connection line is detected, the reference ray taking an initial position of the cleaning device as a ray starting point and the initial travel direction of the cleaning device as a ray direction, the first reference connection line being a line that connects the geometric center of the cleaning device and the starting endpoint.

It should be noted that the initial position is a position where the cleaning device detects the obstacle gap.

In some implementations, the second positional relationship between the reference ray and the first reference connection line includes a first angle absolute value between the reference ray and the first reference connection line.

It can be understood that a first angle between the reference ray and the first reference connection line may vary with the position of the cleaning device when the cleaning device travels forward.

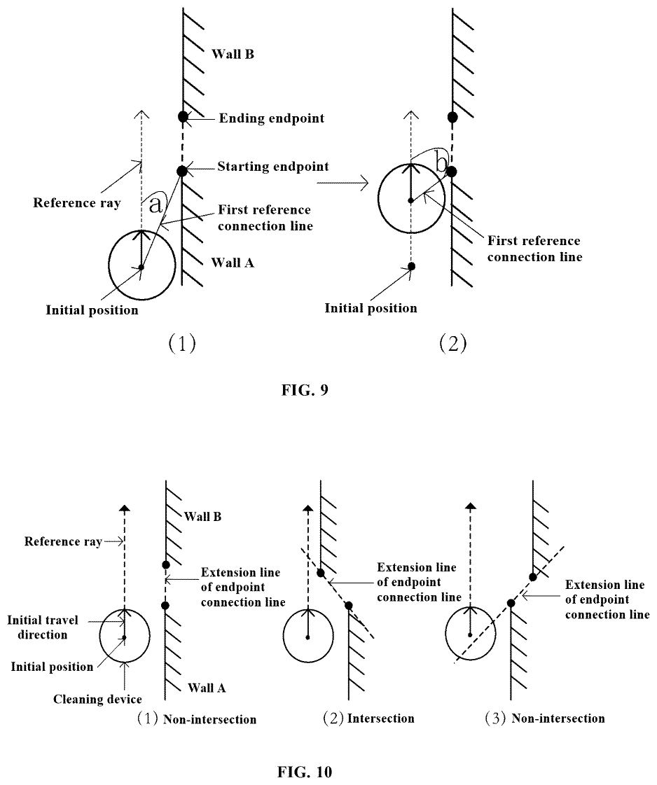

In order to make those skilled in the art better understand the embodiment, an example will be provided below with reference to FIG. 9.

Refer to FIG. 9, which is a schematic diagram of a scenario showing a second positional relationship between a reference ray and a first reference connection line according to an embodiment of the present disclosure.

A scenario corresponding to FIG. 9 is described as below. In FIG. 9(1), the cleaning device detects, at the initial position, the presence of an obstacle gap (i.e., formed between the wall A and the wall B) in the initial travel direction, wherein the first angle between the reference ray and the first reference connection line is an angle a. In FIG. 9(2), the cleaning device continues to move in the initial travel direction from the initial position, and when moving to a certain position, it is detected that the first angle between the reference ray and the first reference connection line is an angle b.

In S200, if the second positional relationship meets a first preset positional relationship, acquisition of a first positional relationship between a geometric center of the cleaning device and the endpoint connection line is triggered.

In some implementations, the first preset positional relationship includes the case where a first angle absolute value between the reference ray and the first reference connection line exceeds a first preset angle threshold.

It can be understood that if it is determined that the first angle absolute value between the reference ray and the first reference connection line exceeds the first preset angle threshold, execution of the above steps S121 to S122 is triggered.

It should be noted that the first preset angle threshold may be determined according to an empirical value, and for example, may be determined as 65°, which is not specifically limited in the present disclosure.

Assuming that the angle a determined in FIG. 9(1) is 30° and the angle b determined in FIG. 9(2) is 65.1°, the cleaning device in FIG. 9(2) may trigger execution of the above steps S121 to S122.

It can be understood that, compared with the first implementation, the second implementation has a requirement for the acquisition time of the first positional relationship between the geometric center of the cleaning device and the endpoint connection line, and the acquisition of the first positional relationship between the geometric center of the cleaning device and the endpoint connection line needs to be triggered at a specific time point. It can be understood that compared with the first implementation, the second implementation can reduce the workload of the cleaning device and improve the processing efficiency of the cleaning device.

The third implementation in S120 may be executed according to the following steps.

The following steps S10 to S20 are executed first, and then the above steps S121 to S122 are executed.

In S10, whether a reference ray intersects with an extension line of the endpoint connection line is determined, the reference ray taking an initial position of the cleaning device as a ray starting point and the initial travel direction of the cleaning device as a ray direction.

In S20, a first positional relationship between a geometric center of the cleaning device and the endpoint connection line is acquired if the extension line of the endpoint connection line intersects with the reference ray.

It can be understood that the cleaning device may be controlled to execute the above steps S121 to S122 if the extension line of the endpoint connection line intersects with the reference ray.

In order to make those skilled in the art better understand the embodiment, an example will be provided below with reference to FIG. 10.

Refer to FIG. 10, which is a schematic diagram of a scenario showing whether an extension line of the endpoint connection line intersects with the reference ray according to an embodiment of the present disclosure.

A scenario corresponding to FIG. 10 is described as below. In FIG. 10(1), the wall A and the wall B are located on the same straight line, and the endpoint connection line formed is parallel to the reference ray, so the reference ray does not intersect with the extension line of the endpoint connection line in this scenario. In FIG. 10(2), the wall B is in a protruding state relative to the wall A, so the reference ray intersects with the extension line of the endpoint connection line in this scenario. In FIG. 10(3), the wall B is in a recessed state relative to the wall A, so the reference ray does not intersect with the extension line of the endpoint connection line in this scenario.

Therefore, in FIG. 10, in the scenario corresponding to FIG. 10(2), the cleaning device is controlled to execute the above steps S121 to S122.

In the third implementation, in the scenario where the extension line of the endpoint connection line does not intersect with the reference ray, the following steps S30 to S50 may be executed.

In S30, if the extension line of the endpoint connection line does not intersect with the reference ray, a curved trajectory is planned for the cleaning device, and whether any other obstacle exists on the curved trajectory is determined.

In S40, the curved trajectory is taken as the target travel trajectory if no other obstacles exists on the curved trajectory.

In S50, a linear trajectory is planned for the cleaning device as the target travel trajectory if any other obstacle exists on the curved trajectory, the linear trajectory being parallel to the endpoint connection line.

Specifically, it can be understood that in FIG. 10, in the scenarios corresponding to FIG. 10(1) and FIG. 10(3), the curved trajectory is preferably planned for the cleaning device. If any other obstacle exists on the determined curved trajectory, the planned curved trajectory is adjusted to a linear trajectory as the target travel trajectory.

It can be understood that, compared with the first implementation, the third implementation does not involve the operation of acquiring the first positional relationship between the geometric center of the cleaning device and the endpoint connection line for all forms of obstacle gaps, but only involves the operation of acquiring the first positional relationship between the geometric center of the cleaning device and the endpoint connection line for a certain specific type of obstacle gap, i.e., involves the operation of acquiring the first positional relationship between the geometric center of the cleaning device and the endpoint connection line only for a type of obstacle gap where the reference ray intersects with the extension line of the endpoint connection line, so that the workload of the cleaning device can be reduced to a certain extent, improving the processing efficiency.

The fourth implementation in S120 may be executed according to the following steps.

The following steps S10 to S12 are executed first, and then the above steps S121 to S122 are executed.

In S10, whether a reference ray intersects with an extension line of the endpoint connection line is determined, the reference ray taking an initial position of the cleaning device as a ray starting point and the initial travel direction of the cleaning device as a ray direction.

In S11, if the extension line of the endpoint connection line intersects with the reference ray, a second positional relationship between the reference ray and a first reference connection line is detected, the reference ray taking an initial position of the cleaning device as a ray starting point and the initial travel direction of the cleaning device as a ray direction, the first reference connection line being a line that connects the geometric center of the cleaning device and the starting endpoint.

In S12, if the second positional relationship meets a first preset positional relationship, acquisition of a first positional relationship between the geometric center of the cleaning device and the endpoint connection line is triggered.

In the fourth implementation, in the scenario where the extension line of the endpoint connection line does not intersect with the reference ray, the above steps S30 to S50 may be executed.

It can be understood that, compared with the third implementation, when it is detected that the reference ray intersects with the extension line of the endpoint connection line, the fourth implementation has a requirement for the acquisition time of the first positional relationship between the geometric center of the cleaning device and the endpoint connection line, and the acquisition of the first positional relationship between the geometric center of the cleaning device and the endpoint connection line needs to be triggered at a specific time point. It can be understood that compared with the third implementation, the fourth implementation can reduce the workload of the cleaning device and improve the processing efficiency of the cleaning device.

In some implementations, the curved trajectory planned for the cleaning device in the present disclosure is either an arc trajectory or a polyline trajectory. It should be noted that the curved trajectory does not include the linear trajectory.

In some implementations, the following steps S123 to S124 may also be executed after step S120.

In S123, a third positional relationship between the perpendicular from the geometric center of the cleaning device to the endpoint connection line and the endpoint connection line is detected.

In some implementations, the third positional relationship includes the case where the perpendicular line from the geometric center of the cleaning device to the endpoint connection line intersects with the endpoint connection line, and the perpendicular line from the geometric center of the cleaning device to the endpoint connection line does not intersect with the endpoint connection line.

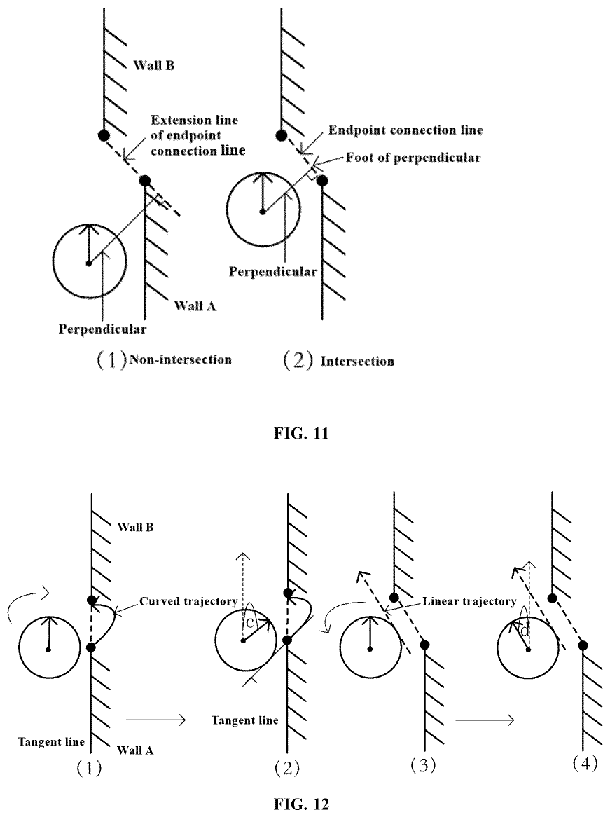

In order to make those skilled in the art better understand the embodiment, an example will be provided below with reference to FIG. 11.

Refer to FIG. 11, which is a schematic diagram of a scenario showing a third positional relationship between the perpendicular from the geometric center of the cleaning device to the endpoint connection line and the endpoint connection line.

A scenario corresponding to FIG. 11 is described as below. In FIG. 11(1), the cleaning device determines at its position that a foot of a perpendicular from the geometric center to the endpoint connection line is located on the extension line of the endpoint connection line, which means that the perpendicular from the geometric center of the cleaning device to the endpoint connection line does not intersect with the endpoint connection line. In FIG. 11(2), the cleaning device determines at its position that a foot of a perpendicular from the geometric center to the endpoint connection line is located on the endpoint connection line, which means that the perpendicular from the geometric center of the cleaning device to the endpoint connection line intersects with the endpoint connection line.

In S124, if the third positional relationship meets a second preset positional relationship, the cleaning device is triggered to rotate in place by a first angle to control the cleaning device to move according to the target travel trajectory.

In some implementations, the second preset positional relationship includes the case where the perpendicular line from the geometric center of the cleaning device to the endpoint connection line intersects with the endpoint connection line.

In some implementations, if the target trajectory is a linear trajectory, the corresponding first angle is an angle absolute value between the reference ray and the linear trajectory. If the target trajectory is a curved trajectory, the corresponding first angle is an angle absolute value between the reference ray and a tangent line, the tangent line being a tangent line at a starting point of the curved trajectory.

In order to make those skilled in the art better understand the embodiment, an example will be provided below with reference to FIG. 12.

Refer to FIG. 12, which is a schematic diagram of a scenario where the cleaning device rotates in place by a first angle according to an embodiment of the present disclosure.

A scenario corresponding to FIG. 12 is described as below. In FIG. 12(1), the target travel trajectory planned for the cleaning device is a curved trajectory, and it is determined that the perpendicular line from the geometric center of the cleaning device to the endpoint connection line intersects with the endpoint connection line. In FIG. 12(2), the cleaning device is controlled to rotate by a first angle (i.e., an angle c, referring to the angle absolute value between the reference ray and the tangent line), so as to control the cleaning device to move according to the planned curved trajectory. In FIG. 12(3), the target travel trajectory planned for the cleaning device is a linear trajectory, and it is determined that the perpendicular line from the geometric center of the cleaning device to the endpoint connection line intersects with the endpoint connection line. In FIG. 12(4), the cleaning device is controlled to rotate by a first angle (i.e., an angle d, referring to the angle absolute value between the reference ray and the linear trajectory), so as to control the cleaning device to move according to the planned linear trajectory.

It can be understood that in this embodiment, there is a requirement for the time at which the cleaning device is triggered to rotate in place by the first angle, and only when the perpendicular from the geometric center of the cleaning device to the endpoint connection line intersects with the endpoint connection line, can the cleaning device be triggered to rotate in place by the first angle, so that the cleaning device can be accurately controlled to enter the target travel trajectory, which is beneficial to controlling the cleaning device to move according to the target travel trajectory.

Continuing to refer to FIG. 1, in S130, the cleaning device is controlled to move according to the target travel trajectory, so as to pass through the obstacle gap.

In some implementations, in the process of controlling the cleaning device to move according to the target travel trajectory, the following steps S131 to S132 may also be executed.

In S131, a second angle absolute value between a current travel direction of the cleaning device and a second reference connection line is detected, the second reference connection line being a line that connects the geometric center of the cleaning device and the ending endpoint.

It can be understood that during the movement of the cleaning device according to the target travel trajectory, the cleaning device may adjust the position of the machine body in real time to adapt to the curved trajectory if the target travel trajectory is a curved trajectory, and during the movement, the travel direction of the cleaning device is constantly changing, so that the second angle absolute value between the current travel direction of the cleaning device and the second reference line changes in real time.

In S132, if the second angle absolute value exceeds a second preset angle threshold, the cleaning device is triggered to rotate by a second angle according to a predetermined action, so as to control the cleaning device to continue to move in the initial travel direction and depart from the obstacle gap.

In some implementations, the predetermined action may be to control the cleaning device to advance while rotating, so that the cleaning device can continue to move in the initial travel direction and depart from the obstacle gap when an angle of rotation reaches the second angle. It can be understood that under this predetermined action, the geometric center of the cleaning device gradually approaches the ending endpoint during the rotation of the cleaning device by the second angle.

In some implementations, the predetermined action may be to control the cleaning device to rotate in place. It can be understood that under this predetermined action, a distance between the geometric center of the cleaning device and the ending endpoint may remain unchanged during the rotation of the cleaning device by the second angle. After the rotation by the second angle, the cleaning device can still continue to move in the initial travel direction and depart from the obstacle gap.

It can be understood that the second preset angle threshold is set to match the predetermined action. If the predetermined action is to advance while rotating, the corresponding second preset angle threshold will be less than the corresponding second preset angle threshold when the predetermined action is to rotate in place. Specifically, the setting of the predetermined action is not limited in the present disclosure, and may be made at will according to actual situations.

In some implementations, if the predetermined action is to travel while rotating, the setting of the second preset angle threshold is related to the position of the sensor mounted on the cleaning device for detecting the ending endpoint. Exemplarily, the second preset angle threshold may be set to 75°, and specifically may be set according to actual situations, which will not be limited in the present disclosure.

In some implementations, if the target trajectory is a linear trajectory, the corresponding second angle is an angle absolute value between the reference ray and the linear trajectory. If the target trajectory is a curved trajectory, the corresponding second angle is an angle absolute value between the reference ray and a tangent line, the tangent line being a tangent line at the end of the curved trajectory.

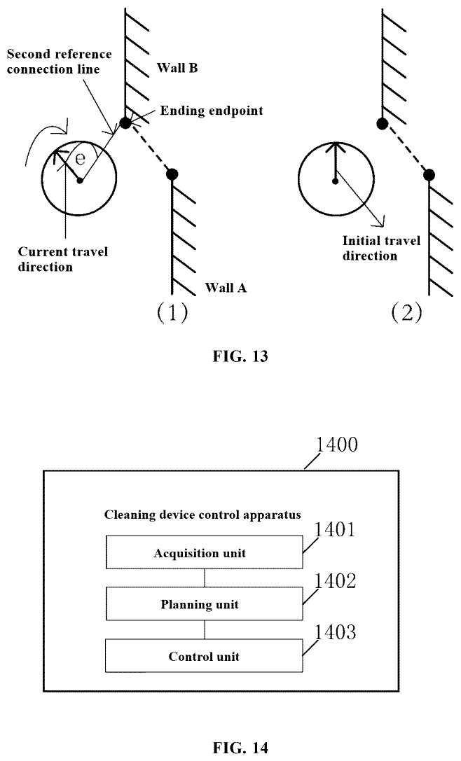

In order to make those skilled in the art better understand the embodiment, an example will be provided below with reference to FIG. 13.

Refer to FIG. 13, which is a schematic diagram of a scenario where the cleaning device rotates by a second angle according to a predetermined action according to an embodiment of the present disclosure.

A scenario corresponding to FIG. 13 is described as below. In FIG. 13(1), the target travel trajectory planned for the cleaning device is a linear trajectory, and the cleaning device determines that an angle e between the current travel direction and the second reference connection line exceeds the second preset angle threshold. In FIG. 13(2), the cleaning device is controlled to rotate by the second angle in an in-place rotating manner, so that the cleaning device can be controlled to continue to depart from the obstacle gap in the initial travel direction.

It can be understood that in this embodiment, there is a requirement for the time at which the cleaning device is triggered to rotate by the second angle according to the predetermined action, and only when the second angle absolute value between the current travel direction of the cleaning device and the second reference connection line exceeds the second preset angle threshold, can the cleaning device be triggered to rotate by the second angle according to the predetermined action, so that the cleaning device can be accurately controlled to depart from the obstacle gap, thereby avoiding scratching the obstacle gap on the basis of sweeping a larger area.

In some implementations of the present disclosure, the cleaning device is controlled to directly enter the obstacle gap if the gap width is greater than or equal to the preset width threshold.

It can be understood that since the gap width of the obstacle gap can accommodate the whole body of the cleaning device, directly controlling the cleaning device to enter the obstacle gap avoids scratching the obstacle gap; and in addition, sweeping the area in the obstacle gap can also be achieved.

In the technical solutions provided by some embodiments of the present disclosure, first, the gap width of the obstacle gap is acquired in response to detecting the presence of the obstacle gap in the initial travel direction of the cleaning device; if the gap width is less than the preset width threshold, the target travel trajectory matching the obstacle gap is planned for the cleaning device; and the cleaning device is controlled to move according to the target travel trajectory, so as to pass through the obstacle gap. Therefore, in the technical solutions of the present disclosure, after detection of the obstacle gap, the target travel trajectory matching the obstacle gap is automatically planned if the width of the obstacle gap is less than the preset width threshold, so that the cleaning device is prevented from directly entering the obstacle gap, which can prevent the cleaning device, failing to enter the obstacle gap and hence exiting, from scratching the obstacle. Correspondingly, the cleaning device is also protected, a larger area can be cleaned, and the cleaning efficiency of the cleaning device is improved.

Based on the same inventive concept, a cleaning device control apparatus is provided according to the embodiments of the present disclosure, and may be used for executing the cleaning device control method in the above embodiments of the present disclosure. For details not disclosed in the embodiments of the present disclosure, please refer to the embodiments of the cleaning device control method described above in the present disclosure.

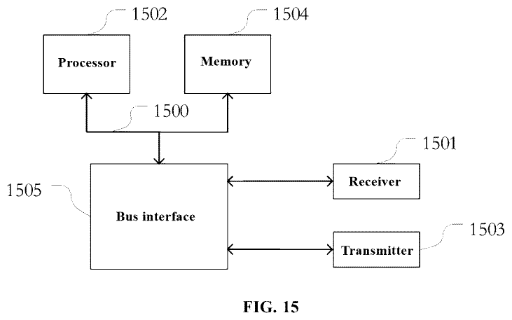

FIG. 14 is a block diagram of a cleaning device control apparatus according to an embodiment of the present disclosure.

As shown in FIG. 14, the cleaning device control apparatus 1400 according to an embodiment of the present disclosure includes an acquisition unit 1401, a planning unit 1402 and a control unit 1403.

The acquisition unit 1401 is configured to, in response to detecting the presence of an obstacle gap in an initial travel direction of a cleaning device, acquire a gap width of the obstacle gap. The planning unit 1402 is configured to, if the gap width is less than a preset width threshold, plan a target travel trajectory that matches the obstacle gap for the cleaning device; and a control unit 1403 is configured to control the cleaning device to move according to the target travel trajectory, so as to pass through the obstacle gap.

In some embodiments of the present disclosure, based on the above-described solution, the gap width is a length of an endpoint connection line, the endpoint connection line is a line that connects two endpoints of the obstacle gap, and the two endpoints include a starting endpoint and an ending endpoint of the obstacle gap in the initial travel direction. The planning unit 1402 is also configured to: acquire a first positional relationship between a geometric center of the cleaning device and the endpoint connection line; and based on the first positional relationship, plan a target travel trajectory that matches the obstacle gap for the cleaning device.

In some embodiments of the present disclosure, based on the above-described solution, the planning unit 1402 is also configured to: before acquiring the first positional relationship between the geometric center of the cleaning device and the endpoint connection line, detect a second positional relationship between a reference ray and a first reference connection line, the reference ray taking an initial position of the cleaning device as a ray starting point and the initial travel direction of the cleaning device as a ray direction, the first reference connection line being a line that connects the geometric center of the cleaning device and the starting endpoint; and if the second positional relationship meets a first preset positional relationship, trigger to acquire a first positional relationship between a geometric center of the cleaning device and the endpoint connection line.

In some embodiments of the present disclosure, based on the above-described solution, the first preset positional relationship includes a case where first angle absolute value between the reference ray and the first reference connection line exceeds a first preset angle threshold.

In some embodiments of the present disclosure, based on the above-described solution, the planning unit 1402 is also configured to: before acquiring the first positional relationship between the geometric center of the cleaning device and the endpoint connection line, detect whether a reference ray intersects with an extension line of the endpoint connection line, the reference ray taking an initial position of the cleaning device as a ray starting point and the initial travel direction of the cleaning device as a ray direction; and acquire a first positional relationship between a geometric center of the cleaning device and the endpoint connection line if the extension line of the endpoint connection line intersects with the reference ray.

In some embodiments of the present disclosure, based on the above-described solution, the planning unit 1402 is also configured to: if the extension line of the endpoint connection line does not intersect with the reference ray, plan a curved trajectory for the cleaning device, and determine whether any other obstacle exists on the curved trajectory; take the curved trajectory as the target travel trajectory if no other obstacles exist on the curved trajectory; and plan a linear trajectory for the cleaning device as the target travel trajectory if any other obstacle exists on the curved trajectory, the linear trajectory being parallel to the endpoint connection line.

In some embodiments of the present disclosure, based on the above-described solution, the planning unit 1402 is also configured to: plan a linear trajectory for the cleaning device as the target travel trajectory if a foot of a perpendicular from the geometric center to the endpoint connection line is close to the ending endpoint, the linear trajectory being parallel to the endpoint connection line.

In some embodiments of the present disclosure, based on the above-described solution, the planning unit 1402 is also configured to: if a foot of a perpendicular from the geometric center to the endpoint connection line is close to the starting endpoint, plan a curved trajectory for the cleaning device, and determine whether any other obstacle exists on the curved trajectory; take the curved trajectory as the target travel trajectory if no other obstacles exist on the curved trajectory; and plan a linear trajectory for the cleaning device as the target travel trajectory if any other obstacle exists on the curved trajectory, the linear trajectory being parallel to the endpoint connection line.

In some embodiments of the present disclosure, based on the above-described solution, the curved trajectory is either an arc trajectory or a polyline trajectory.

In some embodiments of the present disclosure, based on the above-described solution, the planning unit 1402 is also configured to: after planning the target travel trajectory that matches the obstacle gap for the cleaning device, detect a third positional relationship between a perpendicular from a geometric center of the cleaning device to the endpoint connection line and the endpoint connection line; and if the third positional relationship meets a second preset positional relationship, trigger the cleaning device to rotate in place by a first angle to control the cleaning device to move according to the target travel trajectory.

In some embodiments of the present disclosure, based on the above-described solution, the second preset positional relationship includes a case where the perpendicular from the geometric center of the cleaning device to the endpoint connection line intersects with the endpoint connection line.

In some embodiments of the present disclosure, based on the above-described solution, the control unit 1403 is also configured to: in a process of controlling the cleaning device to move according to the target travel trajectory, detect a second angle absolute value between a current travel direction of the cleaning device and a second reference connection line, the second reference connection line being a line that connects the geometric center of the cleaning device and the ending endpoint; and if the second angle absolute value exceeds a second preset angle threshold, trigger the cleaning device to rotate by a second angle according to a predetermined action, so as to control the cleaning device to continue to move in the initial travel direction and depart from the obstacle gap.

In some embodiments of the present disclosure, based on the above-described solution, the control unit 1403 is also configured to: control the cleaning device to directly enter the obstacle gap if the gap width is greater than or equal to the preset width threshold.

In some embodiments of the present disclosure, based on the above solution, the preset width threshold is less than or equal to a body diameter of the cleaning device.

Based on the same inventive concept, a computer-readable storage medium storing at least one program code therein is further provided according to the embodiments of the present disclosure, wherein the at least one program code is loaded and executed by a processor to implement operations executed by the method as described above.

Based on the same inventive concept, a cleaning device is further provided according to the embodiments of the present disclosure.

Referring to FIG. 15, which is a schematic structural diagram of a cleaning device according to an embodiment of the present disclosure. The cleaning device includes one or more memories 1504, one or more processors 1502 and at least one computer program (computer program instruction) stored in the memory 1504 and executable on the processor 1502. The processor 1502, when executing the computer program, implements the method as described above.

In FIG. 15, a bus architecture (represented by a bus 1500) is illustrated. The bus 1500 may include any number of interconnected buses and bridges. The bus 1500 links various circuits of the one or more processors 401 represented by the processor 1502 and the one or more memories represented by the memory 1504 together. The bus 1500 may also link various other circuits such as peripherals, voltage regulators, and power management circuits together, all of which are well-known in the art and thus will not be further described herein. A bus interface 1505 provides an interface between the bus 1500 and a receiver 1501, and between the bus 1500 and a transmitter 1503. The receiver 1501 and the transmitter 1503 may be the same element, i.e., a transceiver, providing a unit for communicating with various other apparatuses on a transmission medium. The processor 1502 is responsible for managing the bus 1500 and usual processing, and the memory 1504 may be used for storing data used by the processor 1502 when performing operations.

The functions described herein may be implemented in hardware, software executed by a processor, firmware, or any combination thereof. The functions, if implemented in software executed by the processor, may be stored in or transmitted via a computer-readable medium as one or more instructions or codes. Other examples and embodiments fall within the scope and spirit of the present disclosure and the appended claims. For example, due to the nature of software, the functions described above may be implemented using software executed by a processor, hardware, firmware, hard wiring, or any combination thereof. In addition, all functional units may be integrated into one processing unit. Alternatively, each unit exists physically independently. Alternatively, two or more units may be integrated into one unit.

In the several embodiments provided by the present disclosure, it should be understood that the disclosed technical contents may be implemented in other manners. The apparatus embodiments described above are merely illustrative. For example, the division of the units may be logical function division. In actual implementation, there may exist other division manners. For example, multiple units or assemblies may be combined or integrated into another system, or some features may be ignored or not executed. In addition, the mutual coupling or direct coupling or communication connection shown or discussed may be indirect coupling or communication connection by certain interfaces, units or modules, which may be in electrical or other forms.

The units described as separate components may or may not be physically separate, and the components as control apparatuses may or may not be physical units, that is, may be located in one place, or may be distributed to multiple network units. Part or all of the units may be selected according to actual needs to achieve the objectives of the solutions of the embodiments of the present disclosure.

The integrated units, when implemented in the form of software functional units and sold or used as independent products, can be stored in a computer-readable storage medium. Based on such understanding, the technical solutions of the present disclosure, in essence or in terms of its contribution to the prior art, or all or part of the technical solutions may be embodied in the form of a software product. The computer software product is stored in a storage medium, including a plurality of instructions, causing a computer device (which may be a personal computer, a server or a network device, etc.) to perform all or part of the steps of the method described in various embodiments of the present disclosure. The foregoing storage medium includes various mediums that can store computer program instructions, such as a U disk, a read-only memory (ROM), a random access memory (RAM), a magnetic disk, or an optical disk.

Described above are only the embodiments of the present disclosure, but not intended to limit the present disclosure. Various changes and modifications may be made to the present disclosure for those skilled in the art. Any modifications, equivalent substitutions, improvements, etc., made within the spirit and principles of the present disclosure should be included within the scope of the claims of the present disclosure.

What is claimed is:

1. A method for controlling a cleaning device, comprising:
in response to detecting the presence of an obstacle gap in an initial travel direction of the cleaning device, acquiring a gap width of the obstacle gap;
if the gap width is less than a preset width threshold, planning a target travel trajectory that matches the obstacle gap for the cleaning device; and
controlling the cleaning device to move according to the target travel trajectory, so as to pass through the obstacle gap.

2. The method according to claim 1, wherein the gap width is a length of an endpoint connection line, the endpoint connection line is a line that connects two endpoints of the obstacle gap, the two endpoints comprise a starting endpoint and an ending endpoint of the obstacle gap in the initial travel direction, and planning the target travel trajectory that matches the obstacle gap for the cleaning device comprises:
acquiring a first positional relationship between a geometric center of the cleaning device and the endpoint connection line; and
based on the first positional relationship, planning the target travel trajectory that matches the obstacle gap for the cleaning device.

3. The method according to claim 2, further comprising:
detecting, before acquiring the first positional relationship between the geometric center of the cleaning device and the endpoint connection line, a second positional relationship between a reference ray and a first reference connection line, the reference ray taking an initial position of the cleaning device as a ray starting point and the initial travel direction of the cleaning device as a ray direction, the first reference connection line being a line that connects a geometric center of the cleaning device and the starting endpoint; and
if the second positional relationship meets a first preset positional relationship, acquiring the first positional relationship between the geometric center of the cleaning device and the endpoint connection line.

4. The method according to claim 3, wherein the first preset positional relationship comprises a case where an absolute value of a first angle between the reference ray and the first reference connection line exceeds a first preset angle threshold.

5. The method according to claim 2, further comprising:
detecting, before acquiring the first positional relationship between the geometric center of the cleaning device and the endpoint connection line, whether a reference ray intersects with an extension line of the endpoint connection line, the reference ray taking an initial position of the cleaning device as a ray starting point and the initial travel direction of the cleaning device as a ray direction; and
if the extension line of the endpoint connection line intersects with the reference ray, acquiring the first positional relationship between the geometric center of the cleaning device and the endpoint connection line.

6. The method according to claim 5, further comprising:
if the extension line of the endpoint connection line does not intersect with the reference ray, planning a curved trajectory for the cleaning device, and determining whether any other obstacle exists on the curved trajectory;
taking the curved trajectory as the target travel trajectory if no other obstacle exists on the curved trajectory; and
planning a linear trajectory for the cleaning device as the target travel trajectory when another obstacle exists on the curved trajectory, the linear trajectory being parallel to the endpoint connection line.

7. The method according to claim 2, wherein based on the first positional relationship, planning the target travel trajectory that matches the obstacle gap for the cleaning device, comprises:
planning a linear trajectory for the cleaning device as the target travel trajectory if a foot of a perpendicular from the geometric center to the endpoint connection line is close to the ending endpoint, the linear trajectory being parallel to the endpoint connection line.

8. The method according to claim 2, wherein based on the first positional relationship, planning the target travel trajectory that matches the obstacle gap for the cleaning device, comprises:
if a foot of a perpendicular from the geometric center to the endpoint connection line is close to the starting endpoint, planning a curved trajectory for the cleaning device, and determining whether any other obstacle exists on the curved trajectory;
taking the curved trajectory as the target travel trajectory if no other obstacle exists on the curved trajectory; and
planning a linear trajectory for the cleaning device as the target travel trajectory if another obstacle exists on the curved trajectory, the linear trajectory being parallel to the endpoint connection line.

9. The method according to claim 6, wherein the curved trajectory is either an arc trajectory or a polyline trajectory.

10. The method according to claim 1, wherein the gap width is a length of an endpoint connection line, the endpoint connection line is a line that connects two endpoints of the obstacle gap, and the method further comprises:
detecting, after planning the target travel trajectory that matches the obstacle gap for the cleaning device, a third positional relationship between a perpendicular from the geometric center of the cleaning device to the endpoint connection line and the endpoint connection line; and
if the third positional relationship meets a second preset positional relationship, triggering the cleaning device to rotate in place by a first angle to control the cleaning device to move according to the target travel trajectory.

11. The method according to claim 10, wherein the second preset positional relationship comprises a case where the perpendicular from the geometric center of the cleaning device to the endpoint connection line intersects with the endpoint connection line.

12. The method according to claim 1, wherein the gap width is a length of an endpoint connection line, the endpoint connection line is a line that connects two endpoints of the obstacle gap, the two endpoints comprise a starting endpoint and an ending endpoint of the obstacle gap in the initial travel direction, and in a process of controlling the cleaning device to move according to the target travel trajectory, the method further comprises:
detecting an absolute value of a second angle between a current travel direction of the cleaning device and a second reference connection line, the second reference connection line being a line that connects the geometric center of the cleaning device and the ending endpoint; and
if the absolute value of the second angle exceeds a second preset angle threshold, triggering the cleaning device to rotate by a second angle according to a predetermined action, so as to control the cleaning device to continue to move in the initial travel direction and to depart from the obstacle gap.

13. The method according to claim 1, further comprising:
if the gap width is greater than or equal to the preset width threshold, controlling the cleaning device to directly enter the obstacle gap.

14. The method according to claim 1, wherein the preset width threshold is greater than or equal to a body diameter of the cleaning device.

15. A non-transitory computer-readable storage medium storing at least one program code therein, wherein the at least one program code is loaded and executed by a processor to implement operations executed by the method according to claim 1.

16. A cleaning device comprising one or more processors and one or more memories, wherein the one or more memories store at least one program code executable by the one or more processors, wherein the one or more processors are configured to:
acquire, in response to detecting the presence of an obstacle gap in an initial travel direction of the cleaning device, a gap width of the obstacle gap;
plan, if the gap width is less than a preset width threshold, a target travel trajectory that matches the obstacle gap for the cleaning device; and
control, the cleaning device to move according to the target travel trajectory, so as to pass through the obstacle gap.

17. The cleaning device according to claim 16, wherein the gap width is a length of an endpoint connection line, the endpoint connection line is a line that connects two endpoints of the obstacle gap, the two endpoints comprise a starting endpoint and an ending endpoint of the obstacle gap in the initial travel direction, and the one or more processors are further configured to:
acquire a first positional relationship between a geometric center of the cleaning device and the endpoint connection line; and
plan, based on the first positional relationship, the target travel trajectory that matches the obstacle gap for the cleaning device.

18. The cleaning device according to claim 17, wherein the one or more processors are further configured to:
detect, before acquiring the first positional relationship between the geometric center of the cleaning device and the endpoint connection line, a second positional relationship between a reference ray and a first reference connection line, the reference ray taking an initial position of the cleaning device as a ray starting point and the initial travel direction of the cleaning device as a ray direction, the first reference connection line being a line that connects a geometric center of the cleaning device and the starting endpoint; and
acquire, if the second positional relationship meets a first preset positional relationship, the first positional relationship between the geometric center of the cleaning device and the endpoint connection line.

19. The cleaning device according to claim 16, wherein the gap width is a length of an endpoint connection line, the endpoint connection line is a line that connects two endpoints of the obstacle gap, and the one or more processors are further configured to:
detect, after planning the target travel trajectory that matches the obstacle gap for the cleaning device, a third positional relationship between a perpendicular from the geometric center of the cleaning device to the endpoint connection line and the endpoint connection line; and
trigger, if the third positional relationship meets a second preset positional relationship, the cleaning device to rotate in place by a first angle to control the cleaning device to move according to the target travel trajectory.

20. The cleaning device according to claim 16, wherein the gap width is a length of an endpoint connection line, the endpoint connection line is a line that connects two endpoints of the obstacle gap, the two endpoints comprise a starting endpoint and an ending endpoint of the obstacle gap in the initial travel direction, and in a process of controlling the cleaning device to move according to the target travel trajectory, the one or more processors are further configured to:
detect, an absolute value of a second angle between a current travel direction of the cleaning device and a second reference connection line, the second reference connection line being a line that connects the geometric center of the cleaning device and the ending endpoint; and
trigger, if the absolute value of the second angle exceeds a second preset angle threshold, the cleaning device to rotate by a second angle according to a predetermined action, so as to control the cleaning device to continue to move in the initial travel direction and to depart from the obstacle gap.
